(19) United States
(12) Patent Application Publication
(10) Pub. No.: US 2011/0230437 A1
(43) Pub. Date: Sep. 22, 2011

(54) ORGANIC COMPOUNDS

(75) Inventors: Gordon Alastair Bell, Berkshire (GB); Clair Louise Harris, Berkshire (GB); Ian David Tovey, Berkshire (GB)

(73) Assignee: SYNGENTA LIMITED, Guildford, Surrey (GB)

(21) Appl. No.: 12/674,741

(22) PCT Filed: Aug. 12, 2008
(86) PCT No.: PCT/GB2008/002738

§ 371 Date: Jun. 13, 2011

(30) Foreign Application Priority Data
Aug. 24, 2007 (GB) 0716593.9

(51) Int. Cl. A01N 43/90; A01N 37/36; A01N 37/18; A01N 43/84; A01N 43/36; A01N 43/40; A01N 43/46

(52) U.S. Cl. 514/53; 514/529; 514/622; 514/237.8; 514/237.5; 514/423; 514/315; 514/217.11

(57) ABSTRACT

A composition comprising a compound of formula I CH₃CH(OH)CC═O)NR¹R² (I) where R¹ and R² are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₅ alkoxy, morpholinyl and NR³R⁴ where R³ and R⁴ are each independently C₁₋₃ alkyl; or phenyl optionally substituted by up to three substituents independently selected from C₁₋₃ alkyl; or R¹ and R² together with the nitrogen atom to which they are attached form a morpholinyl, pyrrolidinyl, piperidinyl or azepanyl ring, each of which is optionally substituted by up to three substituents independently selected from C₁₋₃ alkyl; and at least one agrochemical selected from Othe group consisting of Tri nexepac ethyl, Mandipropamid, Abamcctin and Emamectin, with the proviso that the agrochemical is not abamectin or emamectin when the solvent is N-(B-hydroxyethyl)-lactamide. Such compositions may be, or may be comprised by, emulsion concentrates.

This invention relates to compositions, particularly for agrochemical use, comprising certain lactamides and biologically active compounds, and to methods of making and using such compositions. In particular the present invention relates to such compositions when formulated as, or comprised by, an emulsion concentrate (EC).

An agrochemical (fungicidal) composition comprising dimethyl lactamide and triforine is disclosed in DE 41 12 873 A1.

Certain lactamides are disclosed in Ratchford, W. P. and Fisher, C. H., Journal of Organic Chemistry, 1950, 15, 317-325; Ratchford, W. P., Journal of Organic Chemistry, 1950, 15, 326-332; Fein, M. L. and Filachione, E. M., Journal of the American Chemical Society, 1953, 75, 2097-2099; and U.S. Pat. No. 4,143,159.

Nowadays, the Formulation Chemist is required to address a number of environmental criteria when developing new formulations. Ideally, a suitable solvent will display many or all of the following properties: an excellent dissolving power for pesticides or other biologically active compounds; made from plant or animal renewable resources; low skin irritation; an ability to reduce the skin irritation associated with aggressive formulation components, such as sodium lauryl sulphate; low ecotoxicity, for example to daphnia; low volatile organic content; and a high flash point. The compositions of the present invention comprise a solvent which displays all or many of these attractive properties.

However, not all solvents are equal with respect to their capacity to dissolve biologically active compounds—the nature of the compound and its interaction with the solvent is substantially decisive. It has surprisingly been found that a particular class of solvent is surprisingly effective in dissolving a particular class of biologically active compound.

According to the present invention there is provided a composition comprising a compound of formula I

CH₃CH(OH)C(═O)NR¹R² (I)

where R¹ and R² are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₅ alkoxy, morpholinyl and NR³R⁴ where R³ and R⁴ are each independently C₁₋₃ alkyl; or phenyl optionally substituted by up to three substituents independently selected from C₁₋₃ alkyl; or R¹ and R² together with the nitrogen atom to which they are attached form a morpholinyl, pyrrolidinyl, piperidinyl or azepanyl ring, each of which is optionally substituted by up to three substituents independently selected from C₁₋₃ alkyl;

and at least one agrochemical selected from the group consisting of Trinexepac ethyl, Mandipropamid, Abamectin and Emamectin, with the proviso that the agrochemical is not abamectin or emamectin when the solvent is N-(B-hydroxyethyl)-lactamide.

The structure of Abamectin is shown in FIG. 1.

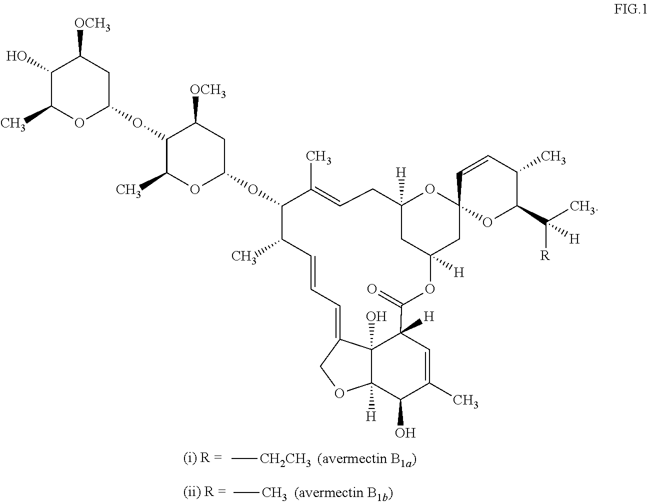

The structure of Emamectin (as the benzoate) is shown in FIG. 2.

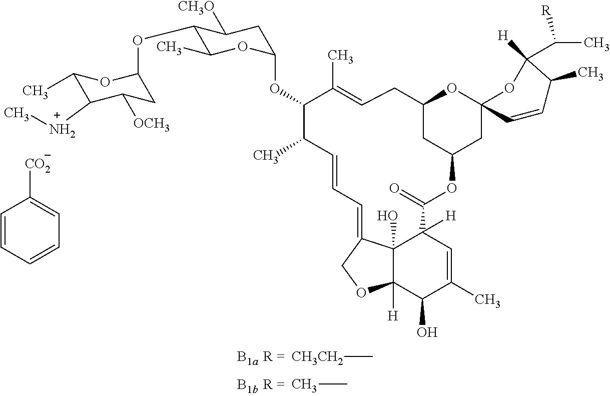

The structure of Trinexepac ethyl is shown in FIG. 3.

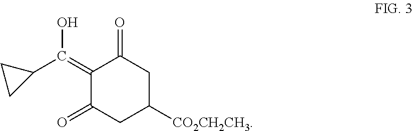

The structure of Mandipropamid is shown in FIG. 4.

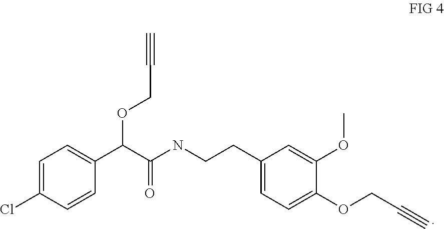

Alkyl groups and moieties are straight or branched chains. Examples are methyl, ethyl, iso-propyl, n-propyl, n-butyl, sec-butyl, tert-butyl, n-amyl and iso-amyl [3-methylbutyl].

Alkenyl groups and moieties may be in the form of straight or branched chains and, where appropriate, may be of either the (E)- or (Z)-configuration. Examples are vinyl and allyl.

Cycloalkyl includes cyclopropyl, cyclopentyl and cyclohexyl.

In one aspect of the composition, in the compound of formula I R¹ and R² are each independently hydrogen; or C₁₋₆ alkyl which is optionally substituted by up to three substituents independently selected from phenyl, hydroxy, C₁₋₃ alkoxy, morpholinyl and NR³R⁴ where R³ and R⁴ are each independently C₁₋₃ alkyl; or R¹ and R² together with the nitrogen atom to which they are attached form a morpholinyl ring which is optionally substituted by up to three substituents independently selected from C₁₋₃ alkyl.

In an even more suitable aspect, R¹ and R² are each independently hydrogen; or C₁₋₆ alkyl; or R¹ and R² together with the nitrogen atom to which they are attached form a morpholinyl ring.

In an even further suitable aspect, R¹ is methyl and R² is methyl, propyl or butyl; or R¹ and R² together with the nitrogen atom to which they are attached form a morpholinyl ring. R³ may be methyl, as may R⁴ . For each optional substituent, it is preferred that it is a methyl group. Suitably alkyl groups are branched; most suitably with methyl groups.

In one embodiment of the composition, in the compound of formula 1, R¹ is not hydrogen, methyl, ethyl, propyl, n-butyl, sec-butyl, iso-butyl, n-amyl, iso-amyl, iso-butylenyl, n-hexyl, 1-3-dimethylbutyl, allyl, CH₂CH₂OH, 2-hydroxypropyl, 2-hydroxy-isobutyl, 1,3-dihydroxy-2-methyl-2-propyl, tris-hydroxy-methyl-methyl, CH₂CH₂OCH₃, cyclohexyl, phenyl, benzyl, α-methylbenzyl, β-phenylethyl, 3-hydroxypropyl or 1-hydroxy-2-butyl when R² is hydrogen;

R¹ is not methyl, allyl or phenyl when R² is methyl;

R¹ is not ethyl when R² is ethyl;

R¹ is not n-butyl when R² is n-butyl;

R¹ is not iso-butyl when R² is iso-butyl;

R¹ is not n-amyl when R² is n-amyl;

R¹ is not iso-amyl when R² is iso-amyl;

R¹ is not n-hexyl when R² is n-hexyl;

R¹ is not allyl when R² is allyl;

R¹ is not butyl or phenyl when R² is phenyl;

R¹ is not benzyl when R² is benzyl;

R¹ is not CH₂CH₂OH or ethyl when R² is CH₂CH₂OH;

R¹ is not 2-hydroxypropyl when R² is 2-hydroxypropyl; and

R¹ and R² together with the nitrogen atom to which they are attached do not form a morpholinyl, pyrrolidinyl or piperidinyl unsubstituted ring.

The composition may further comprise a solvent selected from the group consisting of aliphatic solvents; straight or branched chain paraffins; cyclic hydrocarbons; aromatic solvents; phosphorus containing solvents; sulphur containing solvents; nitrogen containing solvents; aliphatic mono, di or triesters; aromatic mono and di esters; cyclic esters; cyclic, aliphatic and aromatic ketones; alkyl cyclohexanones, diallcyl ketones, acetoacetates, benzyl ketones,; acetophenone; alcohols; cycloalcohols; glycols; glycol ethers and their polymers; propylene glycols; glycol ether acetates; aromatic alcohols; carbonates; ethers and halogenated solvents.

Particularly preferred further solvents are white oil; decalin; mono, di or tri alkylated benzenes; Solvesso 100 or 200ND (t); triethyl phosphate;tributyl phosphate; tri-2-ethyLhexylphosphate;methyl oleate;linoleic acid;linolenic acid;oleic acid;dimethyl decanoamide; tetramethyl sulphone; dimethyl sulphoxide;alkyl ureas; alkanolamines; morpholines; amides; alkyl alkanoates, lactates and acetoacetates; fumarates; succinates;

adipates; maleates; glycerol and citric acid esters;alkyl benzoates; benzyl alkanoates; alkyl salicylates; phthalates and dibenzoates; gamma butyrolactone; caprolactone; terpene fenchone; cyclohexanone; alkyl cyclohexanones; 2-ethylhexanol and other alkyl alcohols; cyclohexanol; tetrahydrofurfuryl alcohol; ethylene and propylene glycol and their polymers; dipropylene glycol; monomethyl or monobutyl ether; dipropylene glycol diacetate or other glycol ether acetates, or tripropylene glycol monobutyl ether; benzyl alcohol; propylene or butylene carbonate; dimethyl isosorbide; alkoxyalkanols; diphenyl ether; chlorobenzene and the chloroalkanes.

The composition may further comprise at least one compound selected from the group consisting of adjuvants, surfactants, polymers, thickening agents, dyestuffs or pigments, ultraviolet light absorbers, anti bacterial agents, salts, density modifiers, stenching or odour improving agents, taste modifiers, cosolvents, and humectants. The surfactant, may be non-ionic (for example a nonylphenol ethoxylate or an alcohol ethoxylate), anionic (for example an alkyl sulphate, such as sodium lauryl sulphate, or a sulphonate, such as calcium dodecylbenzene sulphonate) or cationic (for example a tertiary amine).

The compound of formula 1 may be present in the composition in an amount of from 0.1 to 99% by weight of the composition and the agrochemical, may be present in an amount of 0.1 to 75%, likewise by weight.

In a preferred embodiment of the composition, the compound of formula 1 may be present in an amount of from 0.1 to 99% by weight of the composition, the agrochemical may be present in an amount of 0.1 to 75%, by weight and the solvent may be present in an amount of 0.1 to 90%, likewise by weight.

The ratio of compound of formula 1 to agrochemical to solvent may be varied according to needs, a ratio of 1:1:1 or near to these limits is likely to be valuable for many of the desired formulations however the limits on each component could be as low as 0.01:1 for the ratio of any two parts of the formulation.

The lactamide component of the present compositions may be prepared by reacting a compound of formula (III) [CH₃CH(OH)C(═O)OR⁵ (III)] where OR⁵ is a leaving group, with a compound of formula (II) [HNR¹R² (II)] where R¹ and R² are as defined above. R⁵ may be C₁₋₄ alkyl. This process produces HOR⁵ as a by-product; a cleaner reaction avoids this by-product: the lactamide component of the composition of the present invention may also be prepared by reacting lactide [3,6-dimethyl-[1,4]-dioxane-2,5-dione] with a compound of formula (II) [HNR¹R² (II)] where R¹ and R² areas defined above. Schematically, such a reaction is shown below:

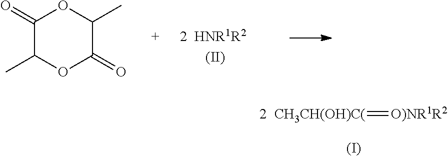

The synthesis is not limited to the above reaction scheme; it illustrates how lactide [3,6-dimethyl-[1,4]-dioxane-2,5-dione] may be converted to a lactamide by reacting lactide with an amine [suitably a primary or secondary amine] which may be carried out under “solvent-free” conditions as the skilled artisan will appreciate.

In a particularly preferred embodiment of the present inventive composition, the ratio of compound of formula 1 to agrochemical to solvent is 1:1:1 or 2:1:1 or 2:1:2 or 3:1:1 or 3:1:2 or 4.5:1:4.5 or 6:1:3 and in a still more preferred embodiment, the compound of formula 1 is dimethyl lactamide (DML).

The skilled man will recognise that the present compositions may be formulated as emulsion concentrates, emulsions in water or oil, microencapsulated formulations, aerosol sprays or fogging formulations; and these may be further formulated into granular materials or powders, for example for dry application or as water-dispersible formulations. The solutions so formed may also be used directly on soil or plants or in other, non-agrochemical, applications.

The particularly preferred formulated form of the composition is as an emulsion concentrate (EC).

The present inventive compositions have a low unwanted toxicity and excellent environmental profile meaning that they are particularly useful in applications where the minimisation of pollution is desired. Examples of such applications include paper making, water treatment, forestry applications, public health treatments, use in municipal pools and other water courses, in applications near rivers, lakes, reservoirs or seas and in applications where release to the atmosphere has to be minimised or controlled and where damage to the atmosphere is not desirable. Examples include use of fungicide containing compositions according to the present invention in exterior and interior paints, coatings, varnishes, waxes or other protectant layers or opacifiers, colourants or screens; in dyeing, pigmentation or the use of inks; in cleaning products designed for the home, garden or industrial applications; and in soap or detergent applications for industrial, home or environmental usage. The compositions of the present invention may also be used in shampoos, and in househould detergents and household cleaners (for example surface cleaners), in which the active ingredient may be a fungicide (possibly azoxystrobin) in the case of shampoo or a bacteriocide in the case of the detergents and cleaners.

The present invention also provides a method of making the inventive composition disclosed above by admixing a compound of formula 1 as indicated above with an agrochemical.

The present invention also provides a method of controlling an agricultural pest comprising application to the pest, to a locus comprising it or to a surface on which it is capable of being present, of a pesticidally effective amount of a composition according to the invention.

The invention still further provides the use of the present inventive composition to control a plant pest.

The compositions of the present invention are particularly valuable in formulations where contact with either human or animal skin or eyes is required or may occur by accident. Applications such as the use of shampoo or body cleaning fluids (such as shower gels, hand or body wipes and medical wipes) may benefit from the safe nature of the lactamide solvent present in the composition, which may form part of a cleaning formulation and which may also reduce the irritancy of some of the other ingredients, such as surfactants. In a similar fashion the irritation to skin or eyes caused by the direct application of pharmaceutical or veterinary compositions to them may be reduced relative to the like application of prior art compositions containing the same pharmaceutically active ingredients.

1. A composition comprising a compound of formula I
CH₃CH(OH)C(═O)NR¹R² (I)
where R¹ and R² are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₆ alkoxy, morpholinyl and NR³R⁴ where R³ and R⁴ are each independently C₁₋₃ alkyl; or phenyl optionally substituted by up to three substituents independently selected from C₁₋₃ alkyl; or R¹ and R² together with the nitrogen atom to which they are attached form a morpholinyl, pyrrolidinyl, piperidinyl or azepanyl ring, each of which is optionally substituted by up to three substituents independently selected from C₁₋₃ alkyl;
and at least one agrochemical selected from the group consisting of Trinexepac ethyl, Mandipropamid, Abamectin and Emamectin, with the proviso that the agrochemical is not abamectin or emamectin when the solvent is N—(B-hydroxyethyl)-lactamide.

2. A composition according to claim 1, wherein in the compound of formula 1 R¹ is not hydrogen, methyl, ethyl, propyl, n-butyl, sec-butyl, iso-butyl, n-amyl, iso-amyl, iso-butylenyl, n-hexyl, 1-3-dimethylbutyl, allyl, CH₂CH₂OH, 2-hydroxypropyl, 2- hydroxy-isobutyl, 1,3-dihydroxy-2-methyl-2-propyl, tris-hydroxy-methyl-methyl, CH₂CH₂OCH₃, cyclohexyl, phenyl, benzyl, α-methylbenzyl, β-phenylethyl, 3-hydroxypropyl or 1-hydroxy-2-butyl when R² is hydrogen;
R¹ is not methyl, allyl or phenyl when R² is methyl;
R¹ is not ethyl when R² is ethyl;
R¹ is not n-butyl when R² is n-butyl;
R¹ is not iso-butyl when R² is iso-butyl;
R¹ is not n-amyl when R² is n-amyl;
R¹ is not iso-amyl when R² is iso-amyl;
R¹ is not n-hexyl when R² is n-hexyl;
R¹ is not allyl when R² is allyl;
R¹ is not butyl or phenyl when R² is phenyl;
R¹ is not benzyl when R² is benzyl;
R¹ is not CH₂CH₂OH or ethyl when R² is CH₂CH₂OH;
R¹ is not 2-hydroxypropyl when R² is 2-hydroxypropyl; and
R¹ and R² together with the nitrogen atom to which they are attached do not form a morpholinyl, pyrrolidinyl or piperidinyl unsubstituted ring.

3. A composition according to claim 1, which further comprises a solvent selected from the group consisting of aliphatic solvents; straight or branched chain paraffins; cyclic hydrocarbons; aromatic solvents; phosphorus containing solvents; sulphur containing solvents; nitrogen containing solvents; aliphatic mono, di or triesters; aromatic mono and di esters; cyclic esters; cyclic, aliphatic and aromatic ketones; alkyl cyclohexanones, dialkyl ketones, acetoacetates, benzyl ketones,; acetophenone; alcohols; cycloalcohols; glycols; glycol ethers and their polymers; propylene glycols; glycol ether acetates; aromatic alcohols; carbonates; ethers and halogenated solvents.

4. A composition according to claim 3, wherein the solvent is selected from the group consisting of white oil; decalin; mono, di or tri alkylated benzenes; Solvesso 100 or 200ND (t); tributyl phosphate or tris-2-ethylhexylphosphate;methyl oleate;linoleic acid;linolenic acid;oleic acid;dimethyl decanoamide; tetramethyl sulphone; dimethyl sulphoxide;alkyl ureas; alkanolamines; morpholines; amides; alkyl alkanoates, lactates and acetoacetates; fumarates; succinates; adipates; maleates; glycerol and citric acid esters;alkyl benzoates; benzyl alkanoates; alkyl salicylates; phthalates and dibenzoates; gamma butyrolactone; caprolactone; terpene fenchone; cyclohexanone; alkyl cyclohexanones; 2-ethylhexanol; cyclohexanol; tetrahydrofurfuryl alcohol; ethylene and propylene glycol and their polymers; dipropylene glycol; monomethyl or monobutyl ether; dipropylene glycol diacetate, or tripropylene glycol monobutyl ether; benzyl alcohol; propylene or butylene carbonate; dimethyl isosorbide; alkoxyalkanols; diphenyl ether; chlorobenzene and the chloroalkanes.

5. A composition according to claim 1, which further comprises at least one compound selected from the group consisting of adjuvants, surfactants, polymers, thickening agents, dyestuffs or pigments, ultraviolet light absorbers, anti bacterial agents, salts, density modifiers, stenching or odour improving agents, taste modifiers, cosolvents, and humectants.

6. A composition according to claim 1, wherein the compound of formula 1 is present in an amount of from 0.1 to 99% by weight of the composition and the agrochemical is present in an amount of 0.1 to 75%, likewise by weight.

7. A composition according to claim 2, wherein the compound of formula 1 is present in an amount of from 0.1 to 99% by weight of the composition, the agrochemical is present in an amount of 0.1 to 75%, by weight and the solvent is present in an amount of 0.1 to 90%, likewise by weight.

8. A composition according to claim 7, wherein the ratio of compound of formula 1 to agrochemical to solvent is defined within the limits 0.01 to 1:0.01 to 1:0.01 to 1.

9. A composition according to claim 8, wherein the ratio of compound of formula 1 to agrochemical to solvent is 1:1:1 or 2:1:1 or 2:1:2 or 3:1:1 or 3:1:2 or 4.5:1:4.5 or 6:1:3.

10. A composition according to claim 1, when formulated as an emulsion concentrate (EC).

11. A method of making a composition according to claim 1, comprising admixing a compound of formula 1 according to claim 1 with an agrochemical according to claim 1.

12. A method of controlling an agricultural pest comprising application to the pest, to a locus comprising it or to a surface on which it is capable of being present, of an pesticidally effective amount of a composition according to claim 1.

13. (canceled)
